(19) United States
(12) Patent Application Publication
(10) Pub. No.: US 2012/0265815 A1
(43) Pub. Date: Oct. 18, 2012

(54) DISTRIBUTED CONFERENCE AND INFORMATION SYSTEM

(75) Inventors: Joel McKee Cooper, Boulder, CO (US); John Bayard Britton, JR., Longmont, CO (US); John Dunn, Denver, CO (US)

(73) Assignee: QSC Audio Products, LLC, Costa Mesa, CA (US)

(21) Appl. No.: 13/451,472

(22) Filed: Apr. 19, 2012

Related U.S. Application Data
(63) Continuation of application No. 12/239,561, filed on Sep. 26, 2008, now abandoned.
(60) Provisional application No. 60/975,434, filed on Sep. 26, 2007.

(51) Int. Cl. G06F 15/16

(52) U.S. Cl. 709/204

(57) ABSTRACT

A distributed conference system is presented herein for providing information to a conference presenter and a group of conference attendees. The distributed conference system includes a main console used by the conference presenter and one or more distributed consoles used by conference attendees. The main console provides a touch screen or other user interface and contains functions that the conference presenter can use to control each of the distributed consoles as well as providing standard room control functions. In addition, the distributed consoles may provide access to additional information for conference attendees and the conference presenter, such as television or other video feeds and a web browser through which they can access the Internet.

### CROSS-REFERENCE TO RELATED APPLICATIONS

This application claims priority to U.S. Provisional Patent Application No. 60/975,434 (Attorney Docket No. 29671-8017.US00) entitled “DISTRIBUTED CONFERENCE AND INFORMATION SYSTEM,” and filed on Sep. 26, 2007, which is hereby incorporated by reference.

### BACKGROUND

Room control systems allow each of the devices at a location (e.g., a classroom, conference room, legislative hall, and so forth) to be controlled from one place. For example, room control systems are often used to dim lights, close drapes, lower a projector screen, and so on. Room control systems often include a touch screen and a control unit that coordinates control of various devices. An operator (e.g., a speaker or conference presenter), uses the touch screen to control the devices at the location. For example, to show a video to a room of people the operator may turn on a projector, dim the lights, lower the projector screen, and select a VCR as the input source for the projector from the control unit. The control unit carries out the instructions received from the touch screen by actuating relays, flipping electronic switches, and so forth. The main purpose is usually to have a single unified user interface for all kinds of hardware that are quite often manufactured by many different, incompatible vendors.

Room control systems are generally simple systems that map a set of existing mechanical functions onto a unified interface. For example, a typical room control system user interface provides a variety of function groups along the bottom of the screen. For example, a source select button allows the operator to change the source that provides input for a projector; a room button allows the operator to control lighting, temperature, and other characteristics of the room; a VCR control button allows the operator to remotely control a VCR; a slide control button allows the operator to move through a slide presentation; and a system off button shuts down the room control system. When the user selects one of the buttons at the bottom, the upper portion of the user interface displays options that are more detailed. For example, if the operator selects the source select button, the top of the screen may contain various input sources that an operator can use with a projector. For example, the operator may be able to select a lectern computer, VCR, document camera, slide presentation, lectern laptop computer, or table laptop computer as input sources and each has an associated button in the user interface of the room control system.

Unfortunately, the controls provided by existing room control systems do not provide many types of information that a presenter or conference attendees may want to access. These systems are generally limited to grouping existing room controls in one place. For example, rather than walking over to the light switch the presenter can manipulate the lights through the touch screen of the room control system. However, the ability to manipulate the lights existed before installing the room control system, and the room control system only adds additional convenience by co-locating the light controls with other room controls. Room control systems usually work in conjunction with a projector, but not all rooms are suitable for a projector. For example, legislative halls are often large so that a projector would be hard for everyone to see, and it is often undesirable to dim the lights so that a projector would be hard to see. In addition, the room control system is generally only accessible to the conference presenter, and thus is not useful to the conference attendees.

There is a need for a system that overcomes the above problems, as well as one that provides additional benefits.

### BRIEF DESCRIPTION OF THE DRAWINGS

FIG. 1 is a block diagram that illustrates components of the distributed conference system, in one embodiment.

FIG. 2 is a flow diagram that illustrates processing of the attendee console to display conference-related information from multiple sources to a conference attendee, in one embodiment.

FIG. 3 is a display page that illustrates an example login view of the distributed conference system, in one embodiment.

FIG. 4 is a display page that illustrates an example agenda view of the distributed conference system, in one embodiment.

FIG. 5 is a display page that illustrates an example web view of the distributed conference system, in one embodiment.

FIG. 6 is a display page that illustrates a document view of the distributed conference system, in one embodiment.

FIG. 7 is a display page that illustrates a messages view of the distributed conference system, in one embodiment.

FIG. 8 is a display page that illustrates a video view of the distributed conference system, in one embodiment.

FIG. 9 is a display page that illustrates a CATV view of the distributed conference system, in one embodiment.

FIG. 10 is a flow diagram that illustrates the processing of the presenter console of the distributed conference system, in one embodiment.

FIG. 11 is a display page that illustrates a document management view of the administrative interface of the distributed conference system, in one embodiment.

FIG. 12 is a display page that illustrates a user management view of the administrative interface of the distributed conference system, in one embodiment.

### DETAILED DESCRIPTION

A distributed conference system is presented herein for providing information to multiple conference attendees. Conference attendees often use a wide variety of information that may not be easily accessible during a conference. For example, legislators often refer to an agenda, review proposed legislative bills, receive/respond to email, monitor activity in other committees, and stay abreast of news that affects their constituents. Each legislator may have a limited amount of space in the legislative hall (e.g., a table) that is not suitable for accessing all of these types of information. For example, the legislator's space may not contain room for a laptop, television, stacks of paper, voting hardware (e.g., buttons), and other resources that are useful for the legislator to perform his/her job. Additionally, attempting to access all the various sources of information may prove excessively distracting from the actual meeting, even if most or all of the data is collocated on a laptop or other personal computer.

The distributed conference system includes one or more distributed consoles used by conference attendees. The system may also include a main or administrative console used by the conference presenter. For example, an installer of the distributed conference system may place the main console at the front of a conference room and a distributed console at each conference attendee's seat for a particular customer's installation. The installer can customize each installation to fit the specific needs of the customer, both in terms of capabilities and aesthetics. The main console provides a touch screen or other user interface and contains functions that the conference presenter can use to control each of the distributed consoles as well as providing standard room control functions. For example, the main console may allow the conference presenter to open a document, navigate to a particular page of the document, and display that page of the document on each of the distributed consoles.

In addition, the distributed consoles may provide access to additional information for conference attendees, such as a web browser through which the conference attendees can access the Internet. For example, the distributed conference system can provide quick and easy access to agendas and calendars, common documents and files, local video (both closed circuit TV, such as from another conference/committee room, and the local presentation feed), live television feeds, messaging, voting/polling, and a host of other features. The distributed conference system presents this information in a set of one or more views, each providing access to a particular type of information. Thus, the distributed conference system provides a unified location for conference attendees to access a variety of information, and allows conference attendees to access information they choose, as well as get a local/close-up copy of what is on the projector through a video/presentation feed.

An example environment where the distributed conference system can be used is a legislative hall, such as federal or state congressional chambers or committee rooms. Members may each have a distributed console at their desk through which they can access information related to bills or other business. For example, during floor debate on a bill a clerk can place documents in the system related to the bill for each representative to view. The documents may include videos, word processing documents, spreadsheets, audio files, and other forms of information related to the bill. Documents may also be restricted to certain groups or individual attendees. For example, one political party may distribute a document to its members that members of another political party cannot view, or a staff member may upload a document for a single user. In some embodiments, representatives can retrieve additional information from the Internet, and can receive messages from other members of their party, pages, the clerk, and so forth. The representatives can also view a video feed of the local presentation (e.g., a video feed copied from the projector or in-room monitors). The system can also be connected to a console outside the room that provides some subset of the same information to observers (e.g., agenda, CCTV, and so on).

### Operating Environment

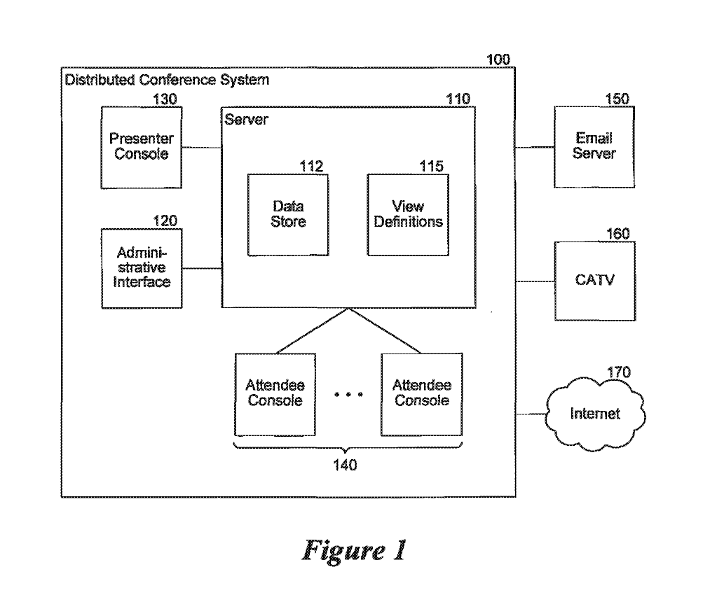

FIG. 1 is a block diagram that illustrates components of the distributed conference system, in one embodiment. The distributed conference system 100 comprises a central server 110, a presenter console 130, and one or more attendee consoles 140. Each of these components is described in further detail herein. The system interacts with external sources of information, such as email server 150, cable television (CATV) provider 160, an in-room presentation feed (not shown), and the Internet or other networks 170. Each of these sources of information provides content that the system 100 can display in the views of the distributed conference system 100.

The central server 110 includes a data store 112 and one or more view definitions 115. The data store 112 stores documents, agendas, configuration, and other information accessed by the system. The view definitions 115 describe the layout of one or more views that the system can provide for the presenter console 130 and each of the attendee consoles 140 to display. For example, the central server 110 may be a web server that provides views as web pages. The presenter console 130 and attendee consoles 140 may include computer systems with a web browser application for viewing the web pages provided by the web server.

The presenter console 130 is a console used by the conference presenter. An administrator can access an administrative interface 120 from the presenter console 130, one of the attendee consoles 140, or a separate PC (e.g., via a web page). The administrative interface 120 provides a way for staff or an administrator to load content into the system, such as agenda items, documents, and so forth. In some installations, there may not be a distinction between presenter and attendee consoles, and all consoles may provide similar access to information. However, when a presenter console 130 is used, the presenter console 130 may have additional features and access to more information than the attendee consoles 140. For example, only the presenter console 130 may be able to change the content displayed by a projector or other main screen in the conference location.

Conference attendees use the attendee consoles 140 to display views provided by the system 100. The attendee consoles 140 may be distributed throughout one or more conference rooms, and on a desk of each of multiple legislators in a legislative chamber. The consoles provide access to internal information, such as documents stored in the data store 112, as well as external information, such as information from the Internet 170. The manufacturer of the system 100 can extend the system by adding additional views and providing a menu for accessing the views on the attendee consoles 140.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on. These communication links can be used to connect the server to the consoles and to connect the server to outside sources of information.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

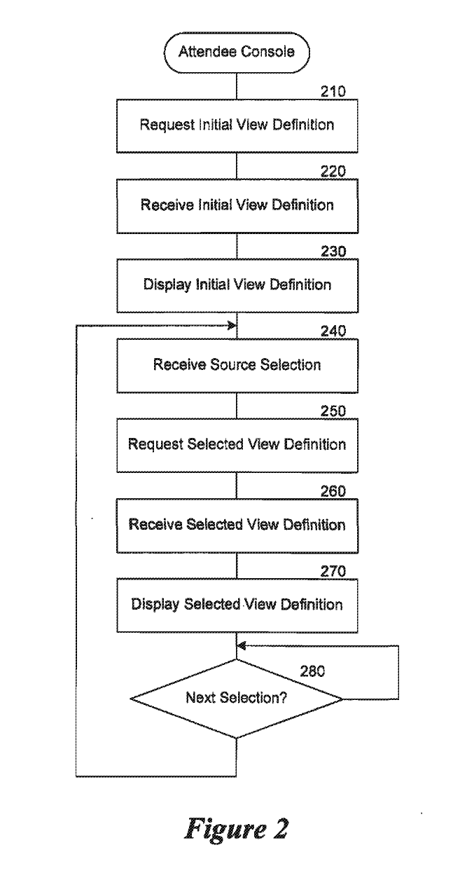

FIG. 2 is a flow diagram that illustrates processing of the attendee console to display conference-related information from multiple sources to a conference attendee, in one embodiment. The system may perform this processing simultaneously on multiple computer systems and each computer system can display different conference-related information. In block 210, the console requests an initial view definition from a server for presenting conference-related information to the conference attendee. For example, the console may request a login view that receives authentication information from the conference attendee. The server may, for example, act as a web server and provide view definitions as web pages. In block 220, the console receives from the server the requested initial view definition, wherein the view definition includes a menu of available sources of conference-related information. For example, the available sources may include an agenda, the Internet, a document store, a video feed, a CATV provider, and a message server. The system may allow an installer, administrator, or presenter to customize the menu of available sources to include sources of information related to a particular type of conference. In block 230, the console displays to the conference attendee the received initial view definition. In block 240, the console receives from the conference attendee a selection of one of the available sources of conference-related information.

In block 250, the console requests from the server a second view definition for viewing conference-related information from the selected source. In block 260, the console receives from the server the requested second view definition, wherein the view definition includes layout information for displaying conference-related information from the selected source. For example, the second view definition may provide an agenda of bills to be discussed to a legislator in a government body. The received second view definition may include conference-related information to which the conference attendee has access and exclude some information stored on the server to which the conference attendee does not have access. For example, the server may store one or more security groups whose members are one or more conference attendees. When providing information or view definitions to the attendee console, the server may determine the group or groups to which the conference attendee belongs and provide information to which that group has access. The system may also allow an administrator to customize the second view definition to include custom information, such as a logo related to a particular type of conference or a closed-circuit video feed related to the conference. In block 270, the console displays to the conference attendee the received second view definition, such that the conference attendee has control of at least some information displayed.

In decision block 280, the console waits for a new selection from the user or other interaction with the displayed user interface. If the user selects a new source of conference-related information, then the console loops to block 240 to receive and process the selection, else the console loops to block 280 to wait for further selections. After block 280, these steps conclude.

### Attendee Console Views

The distributed conference system can present various views to enable the conference presenter and conference attendees to access features of the system. Some example views are described in this section. Those of ordinary skill in the art will recognize other types of views that the system can provide in a manner similar to those described.

In some embodiments, the distributed conference system authenticates conference attendees before allowing access to some functions by presenting a login view. For example, the system may request that a conference attendee provide a username and password before granting access to a mailbox provided by the distributed conference system. Authentication can include simply providing a name, or more sophisticated systems such as placing a finger on a bio-reader, inserting a smartcard into the distributed console, and so forth. Installers can install the distributed conference in a variety of different environments, and the system provides different levels of security based on the requirements of the environment. For example, in secure facilities, access to a room is restricted and a conference attendee's access to the room is sufficient for the distributed conference system to presume that the conference attendee is authorized to access the features of the system. In other environments, such as a public facility, the system may request provide additional information to verify a user's identity before providing access to some or all of the features provided by the distributed conference system.

In one embodiment, the distributed conference system receives configuration settings that specify a login mode. For example, the system may operate in one of three login modes based on the configuration settings: 1) no login, 2) login by name (no password required), and 3) login with password. The no login mode allows a user to access the system from a console without logging in. This implies that there are no security concerns and anyone who has physical access to the console is able to access any available, unrestricted information in the system. Identity-specific features such as voting and personalized messaging may not be available, although non-specific features, such as system-wide messages may be available.

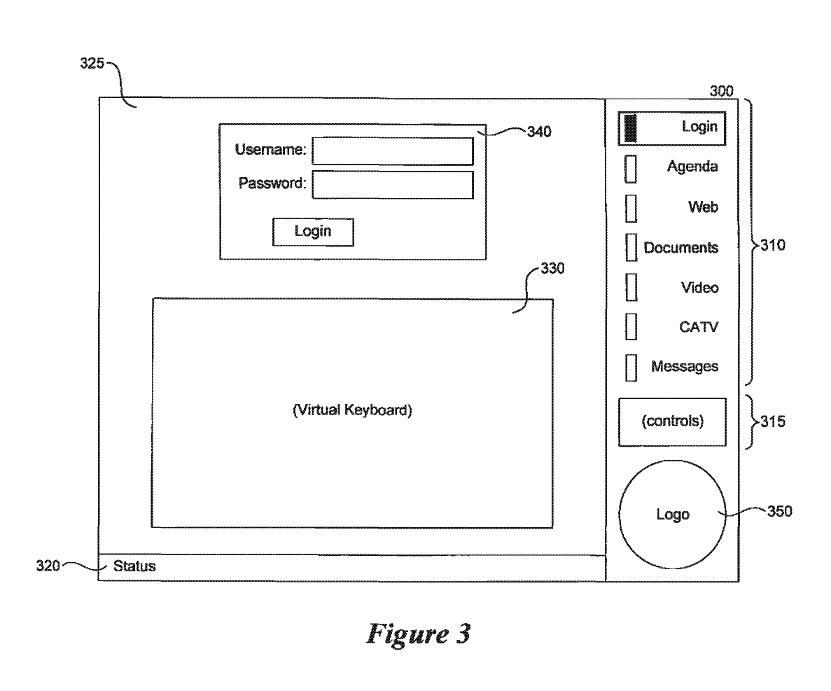

The login by name mode is for situations where security is still not a concern but identity-specific features such as personalized messaging or voting are desired. Users can identify themselves by logging in with their real name or a system username. The system can be configured to allow “guest” access for users that have not identified themselves. Users login either by using an on-screen virtual keyboard or by selecting their name from a drop-down list. In the login with password mode, users provide a username and password for secure authentication. For many systems, a standard login with name/username and password is desired. This option provides not only for more secure messaging and voting, but also enables information access control for users and groups of users. An example of this type of login is presented in FIG. 3.

FIG. 3 is a display page that illustrates an example login view of the distributed conference system, in one embodiment. The display page 300 contains a view selection menu 310, a status bar 320, a virtual keyboard 330, a text entry area 340, and a custom logo 350. For some views, the display page 300 may also include custom controls 315 for interacting with the view. The view selection menu 310 of the illustrated embodiment is a navigation control for switching between views and the system generally displays it within each view so that the user has a consistent interface for switching views. In the figure, the highlight around “Login” on the view selection menu 310 indicates that the user has selected the login view. The contents of the view selection menu 310 may vary by installation based on the features that a particular customer requests. The status bar 320 displays information relevant to the person logged on to the console. After the user successfully logs in, the status bar 320 may display the name of the logged in user, how many messages the user has, the current date and time, and so on. The virtual keyboard 330 provides a touch-based interface for the user to enter the characters that make up the user's username and password. The text entry area 340 receives the characters entered by the user on the virtual keyboard 330, and provides a button to use the received username and password to logon. The custom logo 350 illustrates one type of customization that an installer can perform for the environment of a particular customer.

In some embodiments, the distributed conference system provides an agenda or calendar view. An installer can configure the agenda view to integrate smoothly into a customer's current procedures. The system receives agenda items manually entered by the customer's staff and/or automatically from the system using a central web server or database. The agenda format can be plain text, HTML, or a document format such as Adobe PDF. The agenda view provides information about the day's topics to all conference attendees, and may include private items specific to each conference attendee. For example, an attendee may receive an agenda view with a scheduled vote during the day and a private lunch meeting specific to the attendee.

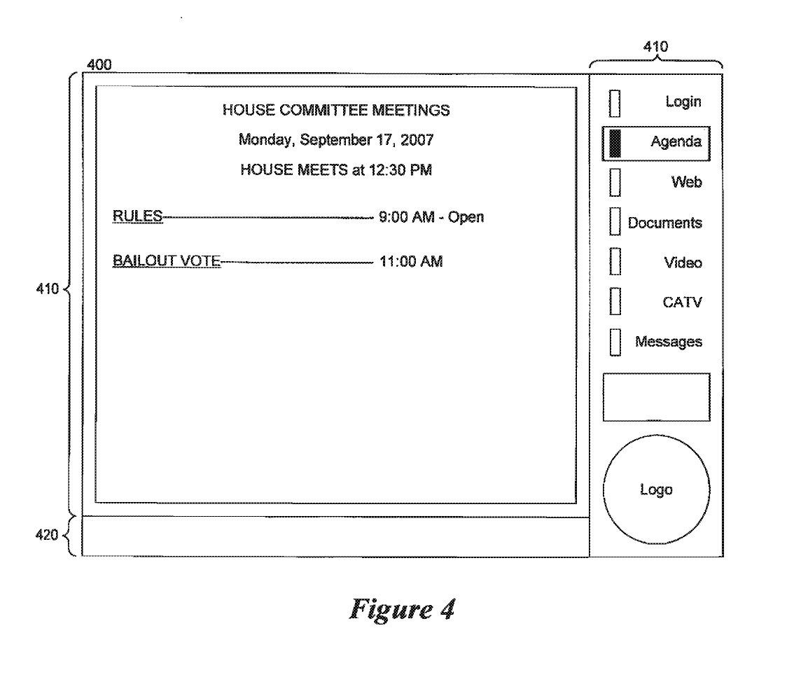

FIG. 4 is a display page that illustrates an example agenda view of the distributed conference system, in one embodiment. The display page 400 contains a similar view selection menu 410 and status bar 420 as other views of the distributed conference system described herein. The display page 400 also contains an agenda display area 430 that displays the events scheduled for the day. For example, the agenda shown indicates that the House of Representatives will meet at 12:30 P.M.

In some embodiments, the distributed conference system provides access to web content through a web browser view. An installer can customize the web browser view to provide access to the Internet, the customer's intranet, or both, Although the web browser view can provide complete and unrestricted Internet access, the distributed conference system may also act as a web filter to restrict access and capabilities for security and/or stability reasons. Since using a virtual keyboard is not second nature for most users, the system may provide a home page of frequently used or approved links to web pages that the user can visit. The system may provide different web content access privileges to different users and groups defined by the system. For example, a legislative assistant may not have the same access as a legislator.

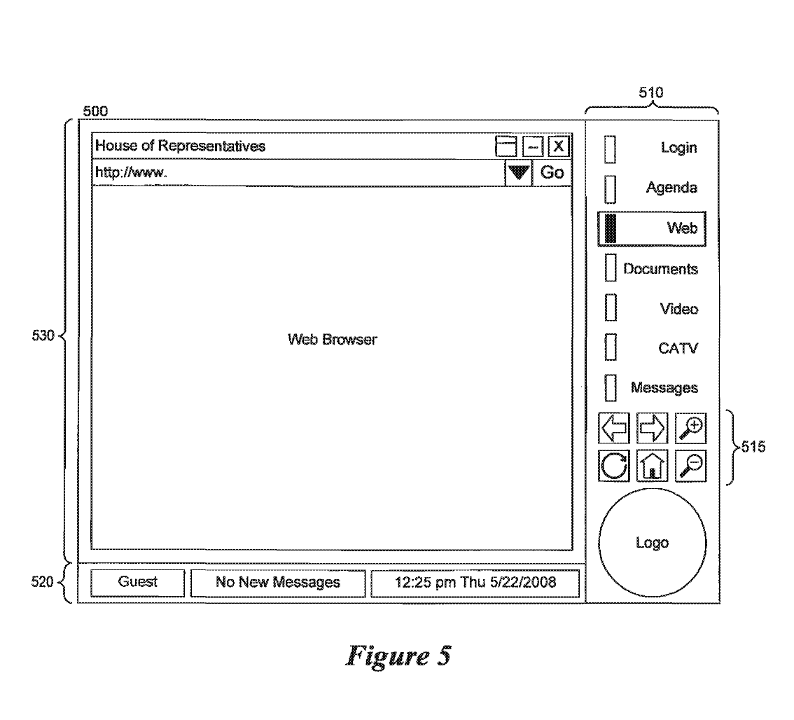

FIG. 5 is a display page that illustrates an example web view of the distributed conference system, in one embodiment. The display page 500 contains a similar view selection menu 510 and status bar 520 as other views of the distributed conference system. The display page 500 includes navigation controls 515 that are useful for interacting with the web view. For example, the navigation controls 515 include navigation buttons for common forward, back, and refresh web browser functions. The navigation controls 515 may also contain additional controls, such as zoom in/out for magnifying the view and home to return to a home page. The display page 500 displays the current web page in a web page display area 530. For example, the web page display area 530 may contain an intranet home page for the legislative hall of the U.S. House of Representatives.

In some embodiments, the distributed conference system provides access to documents. For example, the system may allow attendee consoles to display Microsoft Office documents, Adobe Acrobat PDF documents, videos, and so on. The system can restrict document access to certain users or user groups on a document-by-document basis or based on categories of documents. The distributed conference system allows conference attendees to view documents in various popular formats with a consistent user interface. The distributed conference system may invoke an application associated with the document to view the document. For example, the distributed conference system may invoke Microsoft Word to view a Microsoft Word document. When the system invokes the application, the system may instruct the application to appear in an embedded form, so that the application hides toolbars, status bars, menus, and other user interface elements typically displayed by the application. In this way, the distributed conference system can present a variety of types of documents in a similar format, and users of the system have a unified way of viewing documents of many types.

In addition, the distributed conference system may present its own controls, such as page up and page down, for navigating through documents. The distributed conference system may map these controls to different controls for each application in order to produce similar behavior in each application. For example, if the zoom functions in Microsoft Word and Adobe Acrobat use different keyboard or mouse sequences, the distributed conference system may send those application-specific sequences to the application when a user selects the zoom in control of the distributed conference system.

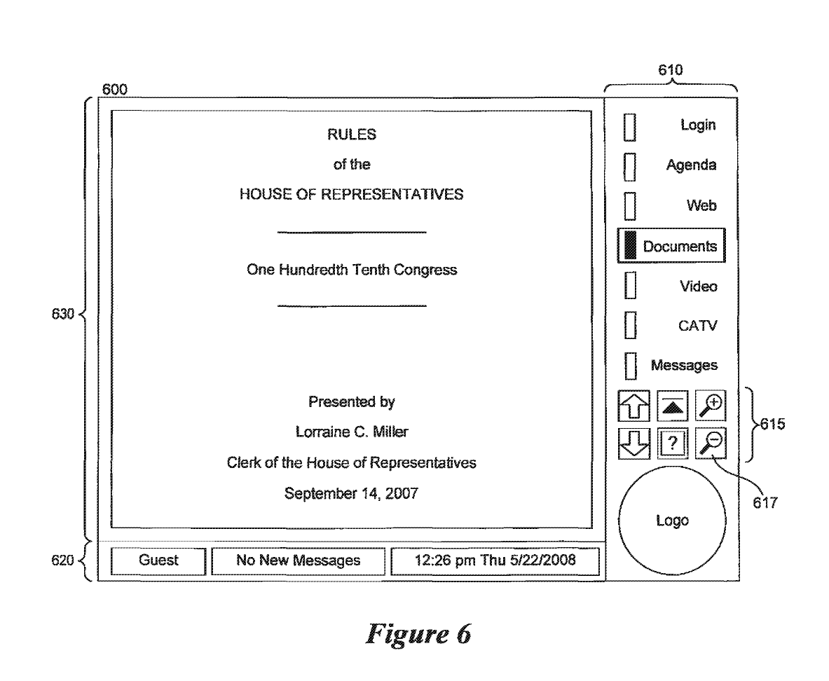

FIG. 6 is a display page that illustrates a document view of the distributed conference system, in one embodiment. The display page 600 contains a similar view selection menu 610 and status bar 620 as other views of the distributed conference system. The display page 600 contains navigation controls 615 that are useful for the document view. For example, the navigation controls 615 include navigation buttons for typical document functions, such as page up/down, home, zoom in/out and go to page #. The navigation controls 615 may be the same regardless of document type, or may provide additional navigation controls related to some types of documents. Some functions, such as go to page #617 may receive additional information (e.g., a page number from a virtual keypad) that a user enters via a popup dialog in the navigation area.

The system may initially present a tree or other control in the document display area 630 that displays a list of documents organized by category (or user or group, such as Democrat/Republican), from which the user can select a document. Only documents available to the user show up in the list of documents. After the user has selected a document, the system displays the document in the document display area 630.

In some embodiments, the distributed conference system provides a mailbox for each conference attendee. The conference attendees can access their mailbox through one of the distributed consoles. Depending on how the system is configured, messages can come from outside the system or inside the system. For example, the conference presenter or other conference attendees may send a message to a particular conference attendee via the administrative interface. Alternatively, an external email system may provide messages from an email server directed to a particular conference attendee, groups of attendees, or the conference presenter.

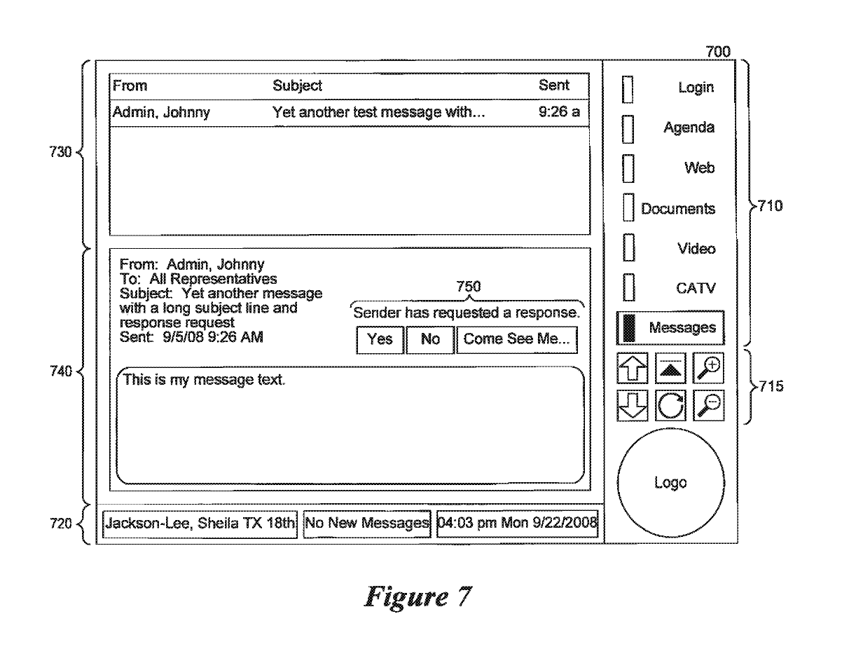

FIG. 7 is a display page that illustrates a messages view of the distributed conference system, in one embodiment. The display page 700 contains a similar view selection menu 710 and status bar 720 as other views of the distributed conference system. The status bar 720 may include information specific to the current view, such as availability of unread messages. The display page 700 contains navigation controls 715 that are useful for the messages view. The display page also contains a message list 730 and a message viewing area 740. The message list 730 lists the messages received by the currently logged on user. For example, the list may display a system-wide message from the conference presenter to all conference attendees or a message specifically to the logged on conference attendee from a staff member. The message viewing area 740 contains the message selected in the message list 730. For example, the message viewing area 740 may display a body of the message and header information, such as who the message is from, when the sender sent the message, and a subject of the message. The message viewing area 740 may also include one or more buttons 750 or other controls for providing a response to the message.

In some embodiments, the distributed conference system provides access to streaming video from one or more video sources. For example, an overhead projector, document scanner, VCR, video-conferencing system, or closed-circuit television (CCTV) cameras may provide video that the system can display through the distributed conference system. For example, a conference attendee may be able to view a camera directed at the conference presenter, a camera directed at a conference attendee that asked a question, and so forth. The distributed conference system may receive an analog or digital video feed from the local video system (CCTV cameras, video conferencing system, video switching device, and so on), prepare the video for distribution (e.g., encoding, mixing, or other video processing), and provide a stream of video to each of the distributed consoles over the communication network. The distributed conference system may also provide controls for switching between cameras or viewing multiple cameras at once on the display of the distributed console.

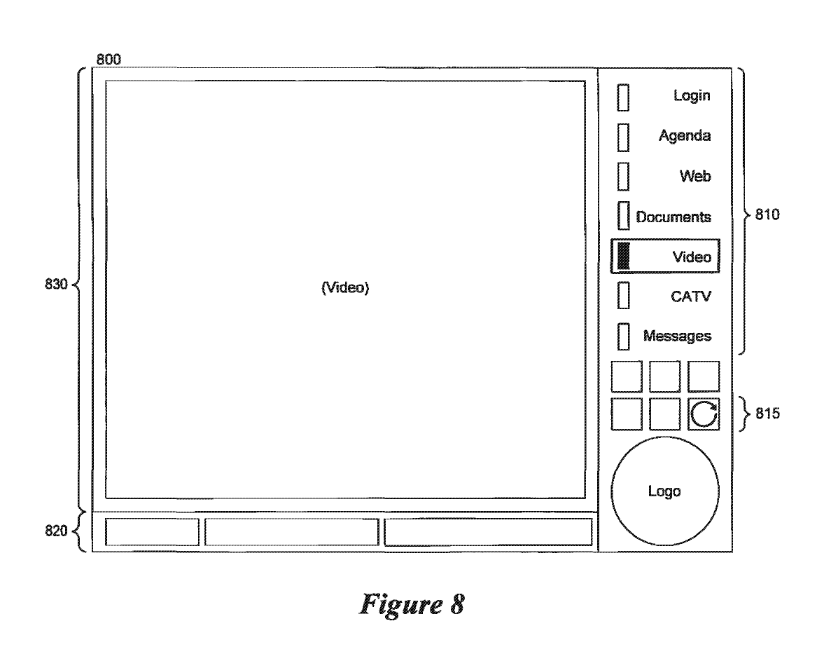

FIG. 8 is a display page that illustrates a video view of the distributed conference system, in one embodiment. The display page 800 contains a similar view selection menu 810 and status bar 820 as other views of the distributed conference system. The display page 800 contains navigation controls 815 that are useful for the video view. The display page 800 also contains a video display area 830. The video view provides access to real-time, live, closed-circuit video, or presentations. If available, the user can select from multiple video sources (not shown here) using the controls 815 or a multi-video display that the system displays in the video display area 830.

In some embodiments, the distributed conference system provides access to television. For example, the distributed conference system may allow conference attendees to view cable television (CATV) during the conference presentation. In some environments, such as legislative halls, access to news and reporting of current events may be useful during debate on a bill. Alternatively, the conference attendees may simply watch CATV for a diversion during breaks or parts of the presentation that are not relevant to them. An operator of the distributed conference system may limit the channels available to each conference attendee or for selected conference attendees. For example, for an installation of the distributed conference system in a legislative hail, the operator may limit the channels to news channels such as MSNBC, CNN, Fox News, CSPAN, and so forth.

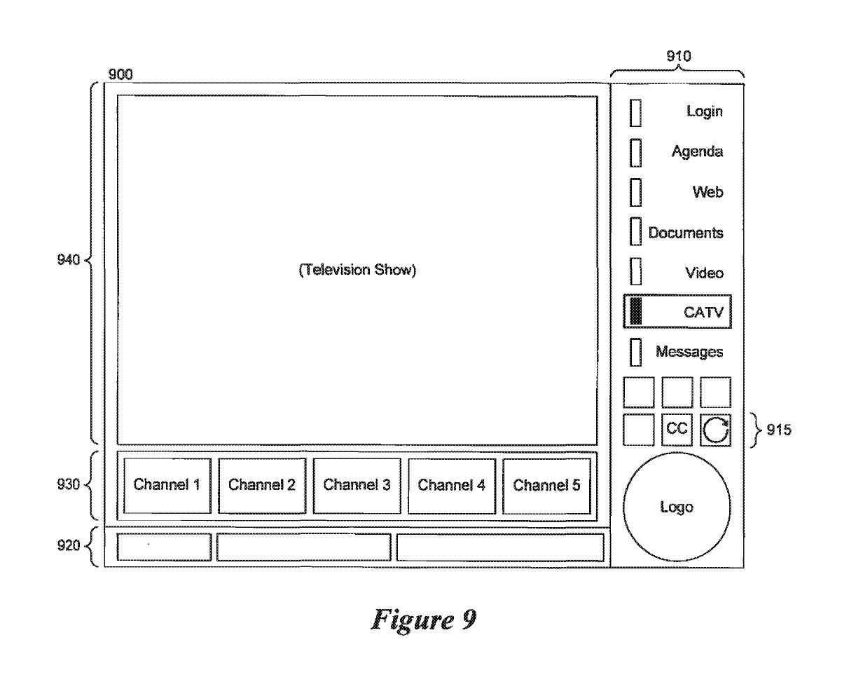

FIG. 9 is a display page that illustrates a CATV view of the distributed conference system, in one embodiment. The CATV view allows conference attendees to watch live television with optional closed-captions. An administrator can select which channels are available for viewing. The display page 900 contains a similar view selection menu 910 and status bar 920 as other views of the distributed conference system. The display page 900 contains navigation controls 915 that are useful for the CATV view, such as a control to enable closed-caption display. The display page 900 also contains a channel selection area 930 and a television display area 940. The channel selection area 930 provides buttons for selecting available channels. An administrator may determine the list of channels in the channel selection area 930 to limit the channels that conference attendees can access. The television display area 940 displays the content of the currently selected television channel. Closed captions may be useful because audio may not be available in the conference area or may be distracting if played during the conference.

In some embodiments, the distributed conference system provides a picture-in-picture mode in which attendees can view a video or CATV stream while viewing other views. For example, if an attendee is viewing the CATV view and switches to another view, the system may continue to display the CATV content in an unused area of the new view. For example, the system may display the CATV content over the logo in the lower right of the illustrated views. The system may provide other features for viewing video and CATV, such as a multi-picture/channel view that allows a conference attendee to see more than one channel at a time on the attendee console screen. For example, the multi-picture/channel view can show CATV channels and an in-room presentation feed. The distributed conference system may also provide a full-screen viewing option. For example, if an attendee double-taps (e.g., clicks) on the main view the system may display video in full screen, and if the attendee double-taps again the system may return to the normal view.

### Backend System

Some of the views that the distributed conference system can provide have been described. Now the backend and administrative interface of the distributed will be described.

In some embodiments, the distributed conference system uses a central web server and each of the consoles is a terminal running a web browser. For example, each console may run a Rich Internet Application (RIA) in a custom web browser to provide the features described herein. RIAs are web applications that have features and functionality similar to traditional desktop applications and typically transfer the processing for the user interface to a web client but keep the bulk of the data (e.g., the state of the program, the data, and so on) on an application server. The features available through the distributed conference system can be determined through the administrative interface, a web site hosted by the central web server to which each distributed console connects. This allows targeting the distributed conference system to a variety of different audiences, such that an installer can customize the system for each installation. Different installations may select varying themes, such as logos, control layouts, colors, textures, and so forth. In addition, an administrator may add or lock out features. For example, a location may not want conference attendees to be able to view CATV, but may want to provide access to additional resources specific to that location. An administrator can support each of these situations by modifying the configuration of the underlying application hosted by the central web server.

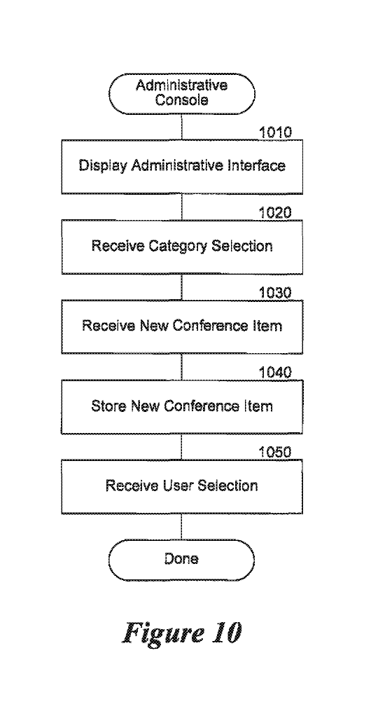

FIG. 10 is a flow diagram that illustrates the processing of the administrative interface of the distributed conference system, in one embodiment. In block 1010, the interface displays the administrative interface to an administrator, wherein the administrative interface includes one or more categories of conference information representing multiple sources of conference information to which the distributed conference system provides access. For example, the administrative interface may have categories related to the views described herein for agenda items, messages, documents, videos, and so forth. The administrator can represent various people with access to modify the system, such as an installer of the system, IT personnel, or a conference presenter. In block 1020, the interface receives from the administrator a selection of one of the categories of conference information. For example, a legislative leader may select the agenda category to upload an agenda for the day's legislative session to the system.

In block 1030, the interface receives from the administrator a new item of conference information to add to the selected category. In the example of an agenda, the interface may receive a word processing document or calendar item that describes the events that are part of the agenda. In block 1040, the interface stores on a server accessible to one or more attendee consoles the received new item of conference information. For example, the system may include a web server with a repository of documents that the system can display to conference attendees. In block 1050, the interface receives from the administrator a selection of one or more users to grant or deny permission to access the new item of conference information and stores the user information on the server. For example, the system may include groups of users such as legislators of one party or another, and when the administrator adds new information to the system, the administrator may select which party's members can access the information.

In some embodiments, the distributed conference system provides an administrative user interface for staff members or other administrators to manage and configure the system. For example, the distributed conference system may provide a web or touch screen interface for management, configuration, and sending administrative messages. The administrative interface may also be available either from any connected PC with a browser or from a dedicated management PC (depending on security and other considerations). Using the administrative interface, staff members can, for example: add and delete users, add and delete staff members, add and delete documents, logout specific users or all users, configure CATV access, send messages, archive messages, update the agenda or calendar, restart the system, and so forth. An administrator may grant different staff members access to specific management features. For example, a conference presenter may not have access to view archived messages or to delete users.

The following paragraphs describe some of the views provided by the administrative interface of the system for managing various aspects of the system.

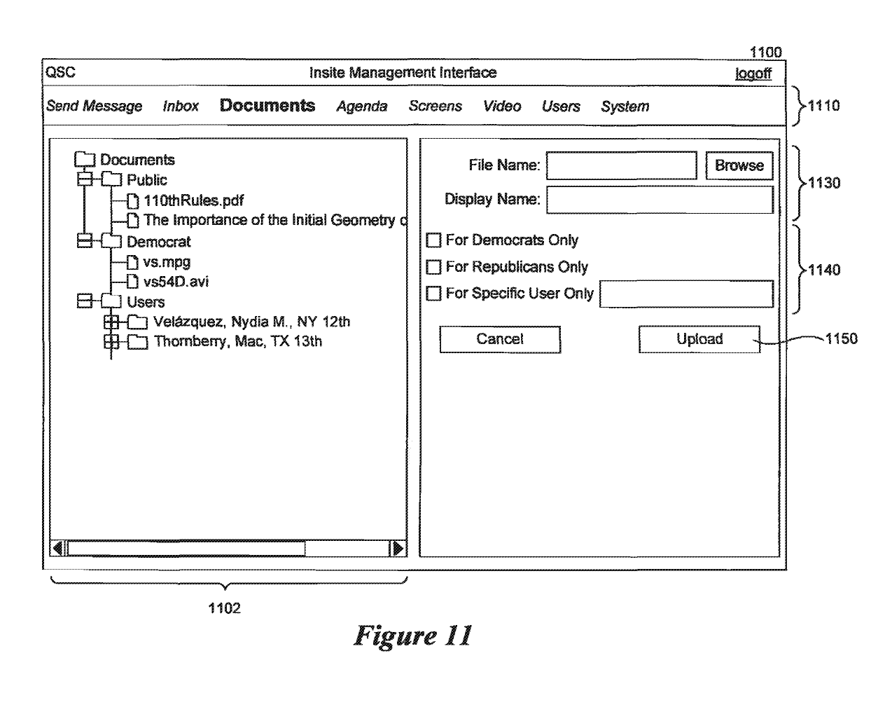

FIG. 11 is a display page that illustrates a document management view of the administrative interface of the distributed conference system, in one embodiment. The display page 1100 includes a menu 1110, a document category list 1120, a document information area 1130, a document access area 1140, and an upload button 1150. The menu 1110 is similar on each page of the administrative user interface and provides a list of views that the administrator can select to manage various aspects of the system. The document category list 1120 organizes documents into categories based on the document purpose and/or the users that can access the document. The document information area 1130 captures information about a new document or modifies information about an existing document that an administrator selects from the document category list 1120. The document information area 1130 may receive a variety of information, such as a display name for the document, an original path to the document, the administrator or user that uploaded the document, and so on. The document access area 1140 receives information about the users that can access the document, such as individual users or groups of users. The upload button 1150 provides a control for the administrator to indicate that he/she has finished providing information about a document and wants to upload the document to the system.

In some embodiments, the distributed conference system provides a message management view. The message management view allows an administrator or other authorized user to send messages from the system to one or more users. The view may allow the administrator to select a recipient of the message, type text for the subject and/or body of the message, and indicate whether the recipient can reply to the message. Because the message may be viewed in an environment with a touch screen where typing can be difficult, the system may provide an option for the message sender to include response buttons with which the recipient can indicate one of several replies with a single selection of the button.

In some embodiments, the distributed conference system provides a system settings view. The system settings view may provide operations that do not fall under other categories, such as restarting the system, logging off users, enabling and disabling various system features, and so forth. The system settings view may also allow an administrator to set the system time and configure a network time protocol (NTP) server for automatically updating the system time.

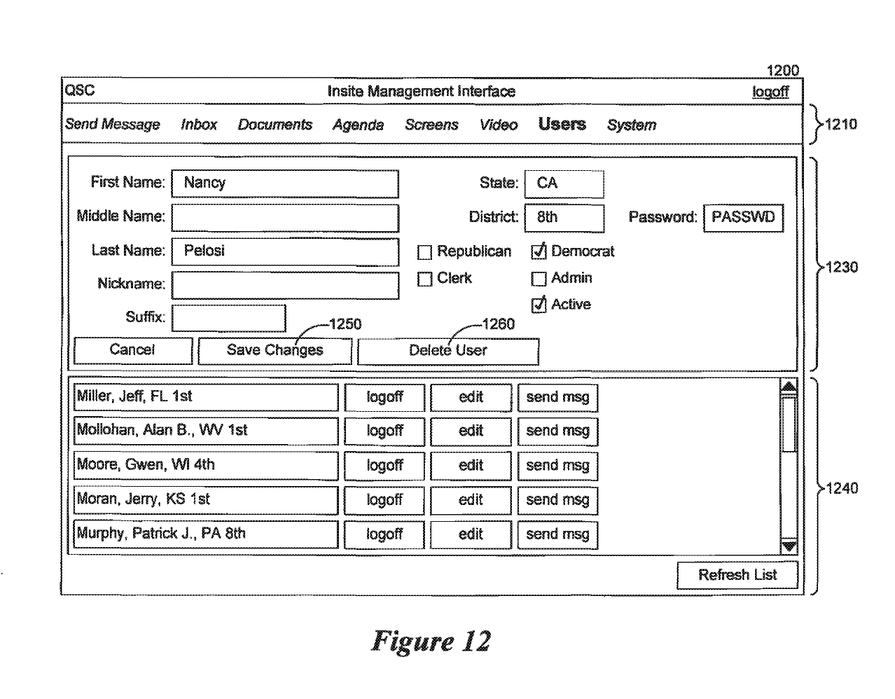

FIG. 12 is a display page that illustrates a user management view of the administrative interface of the distributed conference system, in one embodiment. The display page 1200 includes a menu 1210, a user list 1220, a user information area 1230, a save changes button 1250, and a delete user button 1260. The menu 1210 is similar on each page of the administrative user interface and provides a list of views that the administrator can select to manage various aspects of the system. The user list 1220 provides a list of existing users from which the administrator can select a user to edit, delete, or send a message. The user information area 1230 captures information about a new user or modifies information about an existing user that an administrator selects from the user list 1220. The user information area 1230 may receive a variety of information, such as a user's name, contact information, party affiliation, credentials, and so forth. The save changes button 1250 provides a control for the administrator to indicate that he/she has finished providing information about a user and wants to save the user's information. The delete user button 1260 provides a control for an administrator to remove a selected user from the system.

The system may provide several other administrative views in addition to those described herein. For example, the system may provide an agenda management view for uploading agenda displayed by the attendee console agenda view, a video management view for configuring and selecting video sources that an attendee can view, an administrative inbox view for an administrator to view and respond to messages directed to the administrator, or a screens view for defining the views provided by the system and which users can access them. Those of ordinary skill in the art will recognize numerous options that the system can provide through these and other views.

From the foregoing, it will be appreciated that specific embodiments of the distributed conference system have been described herein for purposes of illustration, but that various modifications may be made without deviating from the spirit and scope of the invention. For example, although several examples have been given, such as classrooms and legislative halls, where the distributed conference system might be use, those of ordinary skill in the art will appreciate that the system can be used in a variety of locations including meeting rooms and hearing rooms, and in a variety of settings including corporate, educational, and government settings. In addition, although some types of documents and information available through the system have been described, many additional types of information can be added to the system such as agendas, calendars, common documents and files, local video, live television feeds, messaging, voting/polling, and so on. Accordingly, the invention is not limited except as by the appended claims.

I/We claim:

1. A computer-implemented method for providing information from multiple sources to a conference attendee, the method comprising:
requesting an initial view definition from a server for presenting conference-related information to a conference attendee;
receiving from the server the requested initial view definition, wherein the view definition includes a menu of available sources of conference-related information;
displaying to the conference attendee the received initial view definition;
receiving from the conference attendee a selection of one of the available sources of conference-related information;
requesting from the server a second view definition for viewing conference-related information from the selected source;
receiving from the server the requested second view definition, wherein the view definition includes layout information for displaying conference-related information from the selected source; and
displaying to the conference attendee the received second view definition, such that the conference attendee has control of at least some information displayed.

2. The method of claim 1 wherein requesting an initial view comprises requesting a login view that receives authentication information from the conference attendee.

3. The method of claim 1 wherein the method operates simultaneously on multiple computer systems and each computer system can display different conference-related information.

4. The method of claim 1 wherein the received second view definition includes conference-related information to which the conference attendee has access and excludes some information stored on the server to which the conference attendee does not have access.

5. The method of claim 1 wherein the conference attendee is a member of a group of users stored at the server, and wherein the server provides the requested second view definition based on the group of which the conference attendee is a member.

6. The method of claim 1 wherein the conference attendee is a legislator and the conference-related information includes legislative information.

7. The method of claim 1 wherein the menu of available sources includes at least some of the sources selected from the group consisting of: an agenda, the Internet, a document store, a video feed, a CATV provider, and a message server.

8. The method of claim 1 wherein the menu of available sources is customizable to include sources of information related to a particular type of conference.

9. The method of claim 1 wherein the second view definition is customizable to include custom information, including a logo related to a particular type of conference.

10. The method of claim 1 wherein the server is a web server and the initial view definition and second view definition are provided as web pages of a Rich Internet Application.

11. A computer system for providing information to multiple conference attendees, the system comprising:
a central server configured to provide one or more views containing information accessible to conference attendees, wherein the central server comprises:
a data store for storing conference information, and
one or more view definitions that describe the information provided by each view; and
one or more distributed attendee consoles accessible to the conference attendees and configured to provide information from the central server by displaying at least one of the view definitions provided by the central server.

12. The system of claim 11 further comprising a presenter console configured to control the flow of information to the multiple distributed consoles.

13. The system of claim 11 wherein the data store stores documents, agendas, configuration, and other information accessed by the system and the view definitions describe the layout of the one or more views.

14. The system of claim 11 wherein the central server receives multiple sources of analog or digital video, encodes the video, and distributes the video to the attendee consoles over a communication network.

15. The system of claim 14 wherein the attendee consoles include a web browser application for viewing the web pages provided by the central server.

16. A computer-readable storage medium encoded with instructions for controlling a computer system to provide an administrative interface for a distributed conference system, by a method comprising:
displaying the administrative interface to an administrator, wherein the administrative interface includes one or more categories of conference information representing multiple sources of conference information to which the distributed conference system provides access;
receiving from the administrator a selection of one of the categories of conference information;
receiving from the administrator a new item of conference information to add to the selected category;
storing on a server accessible to one or more attendee consoles the received new item of conference information.

17. The computer-readable medium of claim 16 further comprising, receiving from the administrator a selection of one or more users to grant permission to access the new item of conference information.

18. The computer-readable medium of claim 16 wherein the new item of conference information includes a system-wide message for the distributed conference system to provide to each attendee console.

19. The computer-readable medium of claim 18 wherein the system-wide message allows each conference attendee at an attendee console to select a response to the system-wide message.

20. The computer-readable medium of claim 16 further comprising, receiving from the administrator information about a new user to add to one or more users permitted to access the distributed conference system.
